(19) United States
(12) Patent Application Publication
(10) Pub. No.: US 2025/0224553 A1
(43) Pub. Date: Jul. 10, 2025

(54) PLASTIC OPTICAL FIBER

(71) Applicant: NITTO DENKO CORPORATION, Ibaraki-shi, Osaka (JP)

(72) Inventors: Satoshi Ito, Osaka (JP); Takashi Shimizu, Osaka (JP); Kazuya Takayama, Osaka (JP); Yasuhiro Koike, Kanagawa (JP)

(73) Assignee: NITTO DENKO CORPORATION, Ibaraki-shi, Osaka (JP)

(21) Appl. No.: 18/850,710

(22) PCT Filed: Mar. 29, 2023
(86) PCT No.: PCT/JP2023/013031

§ 371 Date: Sep. 25, 2024

(30) Foreign Application Priority Data
Mar. 31, 2022 (JP) 2022-061380

(51) Int. Cl. G02B 6/02; C08F 24/00

(52) U.S. Cl. CPC G02B 6/02038; C08F 24/00

(57) ABSTRACT

A plastic optical fiber 10 of the present disclosure includes: a core 11; and a cladding 12 disposed on an outer circumference of the core 11. The plastic optical fiber 10 has a length of 30 m or less. The core 11 has a diameter of 30 μm or more and 100 μm or less. Of the plastic optical fiber 10, a transmission loss at a wavelength of 850 nm is 70 dB/km or more and 500 dB/km or less, and a transmission band at a wavelength of 850 nm is 30 MHz·km or more and 600 MHz·km or less.

### TECHNICAL FIELD

The present invention relates to a plastic optical fiber.

### BACKGROUND ART

Plastic optical fibers include a core, which is a light transmitting portion, located in a central portion and a cladding coating an outer circumference of the core. The core is made of a resin material having a high refractive index. The cladding is made of a resin material having a lower refractive index than that of the resin material of the core so that light will stay within the core.

In recent years, cables capable of transmitting a large volume of data are required also for short-distance communication, for example, in home. Thus, the use of a plastic optical fiber capable of transmitting a large volume of communication signals for short-distance transmission is being considered.

However, the use of plastic optical fibers for short-distance transmission of signals creates a new issue related to signal quality, which has been given no attention in the case of long distance use. Thus, for example, Patent Literature 1 proposes an optical fiber having a length of 100 m or less and an M² value of 1.7 or more as an optical fiber capable of reducing noise in short-distance transmission and enabling high-quality signal transmission. It should be noted that the M² value is a parameter that has been used as a parameter representing the quality of a light beam.

### CITATION LIST

### Patent Literature

Patent Literature 1: JP 2019-049658 A

### SUMMARY OF INVENTION

### Technical Problem

The bit error rate (BER) is a measure of the quality in signal transmission (hereinafter referred to as “transmission quality”). The BER represents how many of transmitted 0 and 1 signals have been received incorrectly, and is determined as a ratio of the number of bit errors to the number of transmitted bits (the number of bit errors/the number of transmitted bits). An optical fiber having a low BER can have high transmission quality.

As described above, as having an M² value of 1.7 or more, the optical fiber disclosed in Patent Literature 1 can reduce noise. However, even the optical fiber having such an M² value and thereby achieving reduction of noise is unable to achieve a low BER in some cases. That is, just increasing the M² value is insufficient for reduction of the BER, and conventional optical fibers leave room for improvement in terms of transmission quality.

Therefore, the present disclosure aims to provide a plastic optical fiber having improved transmission quality in short-distance signal transmission.

### Solution to Problem

The present disclosure provides a plastic optical fiber including:
a core; and
a cladding disposed on an outer circumference of the core, wherein
the plastic optical fiber has a length of 30 m or less,
the core has a diameter of 30 μm or more and 100 μm or less,
a transmission loss at a wavelength of 850 nm is 70 dB/km or more and 500 dB/km or less, and
a transmission band at a wavelength of 850 nm is 30 MHz·km or more and 600 MHz·km or less.

### Advantageous Effects of Invention

The present disclosure can provide a plastic optical fiber having improved transmission quality in short-distance signal transmission.

### BRIEF DESCRIPTION OF DRAWINGS

FIG. 1 is a schematic diagram showing an example of a cross-sectional structure of a plastic optical fiber according to an embodiment of the present disclosure.

FIG. 2 is a schematic diagram showing another example (first modification) of the cross-sectional structure of the plastic optical fiber according to the embodiment of the present disclosure.

FIG. 3 is a schematic diagram showing yet another example (second modification) of the cross-sectional structure of the plastic optical fiber according to the embodiment of the present disclosure.

FIG. 4 is a schematic cross-sectional view showing an example of a manufacturing apparatus that can be used for manufacturing the plastic optical fiber according to the embodiment of the present disclosure.

### DESCRIPTION OF EMBODIMENTS

A first aspect of the present disclosure is a plastic optical fiber including:
a core; and
a cladding disposed on an outer circumference of the core, wherein
the plastic optical fiber has a length of 30 m or less,
the core has a diameter of 30 μm or more and 100 μm or less,
a transmission loss at a wavelength of 850 nm is 70 dB/km or more and 500 dB/km or less, and
a transmission band at a wavelength of 850 nm is 30 MHz·km or more and 600 MHz·km or less.

According to a second aspect of the present disclosure, for example, the plastic optical fiber according to the first aspect is a graded-index plastic optical fiber.

According to a third aspect of the present disclosure, for example, in the plastic optical fiber according to the first or second aspect, the core includes a first resin, and the first resin is at least one selected from the group consisting of a fully fluorinated resin, a partially fluorinated resin, a partially chlorinated resin, and a partially deuterated resin.

According to a fourth aspect of the present disclosure, for example, in the plastic optical fiber according to the third aspect, the first resin is at least one selected from the group consisting of the fully fluorinated resin and the partially fluorinated resin.

According to a fifth aspect of the present disclosure, for example, in the plastic optical fiber according to the fourth aspect, the first resin includes a fluorine-containing polymer including a structural unit (A) represented by the following formula (1):

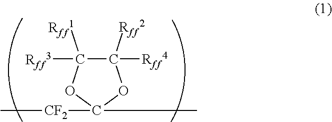

where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are optionally linked to form a ring.

According to a sixth aspect of the present disclosure, for example, in the plastic optical fiber according to the fifth aspect, the fluorine-containing polymer further includes a structural unit (B) represented by the following formula (2):

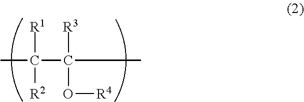

where R¹ to R³ each independently represent a fluorine atom or a perfluoroalkyl group having 1 to 7 carbon atoms, R⁴ represents a perfluoroalkyl group having 1 to 7 carbon atoms, the perfluoroalkyl group optionally has a ring structure, one or some of the fluorine atoms are each optionally substituted by a halogen atom other than a fluorine atom, and one or some of fluorine atoms in the perfluoroalkyl group are each optionally substituted by a halogen atom other than a fluorine atom.

According to a seventh aspect of the present disclosure, for example, in the plastic optical fiber according to the fifth or sixth aspect, the fluorine-containing polymer further includes a structural unit (C) represented by the following formula (3):

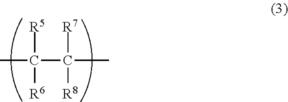

where R⁵ to R⁸ each independently represent a fluorine atom or a perfluoroalkyl group having 1 to 7 carbon atoms, the perfluoroalkyl group optionally has a ring structure, one or some of the fluorine atoms are each optionally substituted by a halogen atom other than a fluorine atom, and one or some of fluorine atoms in the perfluoroalkyl group are each optionally substituted by a halogen atom other than a fluorine atom.

According to an eighth aspect of the present disclosure, for example, in the plastic optical fiber according to any one of the fifth to seventh aspects, the fluorine-containing polymer further includes a structural unit (D) represented by the following formula (4):

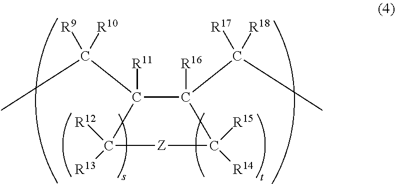

where Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms, one or some of the fluorine atoms are each optionally substituted by a halogen atom other than a fluorine atom, one or some of fluorine atoms in the perfluoroalkyl group are each optionally substituted by a halogen atom other than a fluorine atom, one or some of fluorine atoms in the perfluoroalkoxy group are each optionally substituted by a halogen atom other than a fluorine atom, s and t are each independently 0 to 5, and s+t is an integer of 1 to 6 or, in the case where Z is —OC(R¹⁹R²⁰)O—, s+t is optionally 0.

According to a ninth aspect of the present disclosure, for example, in the plastic optical fiber according to any one of the third to eighth aspects, the core further includes a refractive index modifier.

According to a tenth aspect of the present disclosure, for example, the plastic optical fiber according to any one of the first to ninth aspects further includes a reinforcing layer disposed on an outer circumference of the cladding.

An embodiment of a plastic optical fiber (hereinafter referred to as “POF”) of the present disclosure will be described. The POF of the present embodiment includes: a core; and a cladding disposed on an outer circumference of the core. The POF of the present embodiment is, for example, a graded-index (GI) POF.

FIG. 1 shows an example of a cross-sectional structure of the POF according to the present embodiment.

A POF 10 shown in FIG. 1 includes a core 11 and a cladding 12 disposed on an outer circumference of the core 11.

The POF 10 of the present embodiment has a length of 30 m or less. Here, the length of the POF 10 refers to an axial length of the POF 10. That is, the POF 10 of the present embodiment is used for short-distance signal transmission, and is usable also, for example, in home. Moreover, in the POF 10 of the present embodiment, the core 11 has a diameter of 30 μm or more and 100 μm or less. In the POF 10 of the present embodiment having such a length and such a core diameter, a transmission loss at a wavelength of 850 nm is 70 dB/km or more and 500 dB/km or less, and a transmission band at a wavelength of 850 nm is 30 MHz·km or more and 600 MHz·km or less.

Herein, the diameter (hereinafter referred to as “core diameter”) of the core 11 refers to a diameter at which the light intensity measured by a near field pattern (NFP) method, which is one of methods according to IEC 60793-1-20 and IEC 60793-2-40 subcategory A4h, using light with a wavelength of 850 nm is 5%. The transmission loss of the POF 10 at a wavelength of 850 nm is a value measured by a cut-back method, which is one of methods according to IEC 60793-1-40. The transmission band of the POF 10 is a value measured by a pulse method, which is one of methods according to IEC 60793-1-41.

Since the transmission loss and the transmission band of the POF 10 of the present embodiment satisfy the above ranges, the POF 10 of the present embodiment can achieve a low BER despite its short length and small core diameter falling within the ranges, as described above, where noise is relatively likely to be generated. The BER is, as described above, the ratio of the number of bit errors to the number of transmitted bits (the number of bit errors/the number of transmitted bits), and is a measure of the transmission quality. A low BER means high transmission quality. Therefore, the POF 10 of the present embodiment can achieve improved transmission quality in short-distance signal transmission. The BER of the POF 10 is preferably 1×10⁻⁷ or less, and more preferably 1×10⁻⁸ or less.

As described above, the length of the POF 10 of the present embodiment is 30 m or less. The length of the POF 10 of the present embodiment may be, for example, 20 m or less, 15 m or less, or 10 m or less. The POF 10 of the present embodiment can achieve high transmission quality even when the POF 10 is for shorter distance use as described above. The length of the POF 10 of the present embodiment is required to be more than 0 m, and may be, for example, 0.1 m or more.

As described above, the core diameter of the POF 10 of the present embodiment is 30 μm or more and 100 μm or less. The core diameter may be 80 μm or less, 60 μm or less, or 55 μm or less. The core diameter may be 40 μm or more, or 45 μm or more.

As described above, of the POF 10 of the present embodiment, the transmission loss at a wavelength of 850 nm is 70 dB/km or more and 500 dB/km or less, and the transmission band at a wavelength of 850 nm is 30 MHz·km or more and 600 MHz·km or less. The transmission loss and the transmission band are each a factor that affects the BER. The transmission loss is also correlated with noise. Hence, noise is indirectly controlled in an appropriate range by controlling the transmission loss within the above range. Controlling the transmission loss and the transmission band in combination within the above ranges can decrease the BER of the POF 10 of the present embodiment. A preferable combination of the ranges of the transmission loss and the transmission band can be determined as appropriate taking account of, for example, a material (for example, the type of resin) of the core 11.

The transmission loss at a wavelength of 850 nm is preferably 70 dB/km or more and 400 dB/km or less, more preferably 70 dB/km or more and 350 dB/km or less, even more preferably 80 dB/km or more and 300 dB/km or less.

The transmission band at a wavelength of 850 nm is preferably 50 MHz·km or more and 580 MHz·km or less, more preferably 60 MHz·km or more and 560 MHz·km or less, even more preferably 70 MHz·km or more and 540 MHz·km or less.

The transmission loss of the POF 10 of the present embodiment can be controlled in the above range, for example, by conditions for manufacturing the POF 10, specifically, for example, by filtering conditions for removing foreign matters, such as tiny unwanted matters, from the materials of the POF 10 (for example, the materials of the core 11 and the cladding 12). Filtering conditions that are so appropriate that the transmission loss at a wavelength of 850 nm will be 70 dB/km or more and 500 dB/km or less can be determined, for example, taking into account the type of resin used as a material and an additive such as a refractive index modifier.

Moreover, it is preferable that, for example, the material of the POF 10 (for example, the material of the core 11 and the material of the cladding 12) be subjected to high-temperature heating treatment so that the POF 10 of the present embodiment will have a transmission loss in the above range. By the heating treatment can be removed organic impurities such as a by-product of resin synthesis. Such organic impurities causes scattering. Hence, by the high-temperature heating treatment can be obtained the POF 10 having a low transmission loss and including a reduced amount of an organic scatterer. The temperature of the heating treatment depends on the types of, for example, resins used as the materials of the core 11 and the cladding 12. For example, when the glass transition temperature of the resin used is expressed as Tg, the temperature of the heating treatment is preferably Tg+70° C. or higher, more preferably Tg+90° C. or higher, and even more preferably Tg+110° C. or higher. For example, when a polymer of perfluoro-4-methyl-2-methylene-1,3-dioxolane is used as in EXMAPLES below, the temperature of the heating treatment is preferably 220° C. or higher, more preferably 240° C. or higher, and even more preferably 250° C. or higher.

The transmission band of the POF 10 of the present embodiment can be controlled in the above range, for example, by controlling a refractive-index distribution of the core 11. Specifically, conditions that are for diffusing a refractive index modifier in the material of the core 11 and that are so appropriate that the transmission band will be 30 MHz·km or more and 600 MHz·km or less can be determined, for example, taking into account the type of resin used as a material and the refractive index modifier. The conditions for diffusing the refractive index modifier are, for example, the time required for a fiber structure being a precursor of the POF 10 to pass through a diffusion tube, the length of the diffusion tube, the setting temperature of the diffusion tube, and the spinning rate.

It is preferable that the POF 10 of the present embodiment have a first end from which light is input and a second end from which light is output and that the M² value of the light output from the second end side be 1.7 or more. As described in JP 2019-049658 A (Patent Literature 1) being a prior application by the applicant of the present invention, by applying the M² value that has been used as a parameter representing the quality of a light beam to a design value of an optical fiber for short-distance communication, in other words, by controlling the M² value to 1.7 or more, optical feedback from the second end being an output end to the first end being an input end spatially expands and the amount of light going back into a light source such as a VCSEL is reduced. Thus, optical feedback noise can be reduced. For this reason, when having an M² value of 1.7 or more, the POF 10 of the present embodiment can further improve the transmission quality. The upper limit of the M² value is not particularly limited, and may be, for example, 6 or less or 5 or less. The M² value can be controlled to a desired value, for example, by the type of the material of the core 11 and the conditions for manufacturing the POF 10.

Hereinafter, each components of the POF 10 of the present embodiment will be described in more details.

### (Core 11)

The core 11 is a portion configured to transmit light. The core 11 has a higher refractive index than that of the cladding 12. Because of this, light incident on the core 11 is trapped inside the core 11 by the cladding 12 and propagates in the POF 10.

The core 11 includes a first resin. The core 11 may include the first resin as its main component. Here, saying that the core 11 includes the first resin as its main component means that the first resin is a component whose content is highest in the core 11 on a mass basis. The first resin content in the core 11 may be 75 mass % or more, 80 mass % or more, or 85 mass % or more.

The core 11 may further include an additive in addition to the first resin. The additive is, for example, a refractive index modifier. That is, the core 11 may be made of a resin composition including the first resin and the additive such as the refractive index modifier. The refractive index modifier can be, for example, a known refractive index modifier used as the material of the core 11 of the POF 10. The material of the core 11 may include an additive other than the refractive index modifier.

In the case where the POF 10 of the present embodiment is, for example, a GI POF, the core 11 has a refractive-index distribution in which the refractive index varies in a radius direction. Such a refractive-index distribution can be formed, for example, by adding the refractive index modifier to the first resin and diffusing the refractive index modifier inside the first resin (for example, by thermal diffusion).

The first resin included in the core 11 is not limited to a particular resin as long as the first resin is a resin having a high transparency. Examples of the first resin include fluorine-containing resins, acrylic resins such as methyl methacrylate, styrene resins, and carbonate resins.

The first resin included in the core 11 may be at least one selected from the group consisting of a fully fluorinated resin, a partially fluorinated resin, a partially chlorinated resin, and a partially deuterated resin. A partially fluorinated resin, a partially chlorinated resin, and a partially deuterated resin herein each refer to a resin which is based on a resin known as a core material of POFs in this technical field and in which one or some of hydrogen atoms in C—H bonds are fluorinated, chlorinated, or deuterated. A fully fluorinated resin herein refers to a resin which is based on a resin known as a core material of POFs in this technical field and in which every hydrogen atom in C—H bonds is fluorinated. Examples of the resins known as core materials in this technical field include, as described above, acrylic resins such as methyl methacrylate, styrene resins, and carbonate resins. A polymer having an aliphatic ring structure, such as a polymer having a dioxolane structure, may be used.

The first resin is desirably at least one selected from the group consisting of the fully fluorinated resin and the partially fluorinated resin. That is, the first resin is desirably a fluorine-containing resin.

The first resin of the core 11 is preferably a fluorine-containing resin including a fluorine-containing polymer. Hereinafter, the fluorine-containing resin included in the core 11 is referred to as a first fluorine-containing resin, and the fluorine-containing polymer included in the first fluorine-containing resin is referred to as a first fluorine-containing polymer.

It is preferred from the viewpoint of reducing light absorption attributable to stretching energy of a C—H bond that the first fluorine-containing polymer included in the first fluorine-containing resin be substantially free of a hydrogen atom, and it is particularly preferred that every hydrogen atom bonded to a carbon atom be substituted by a fluorine atom. That is, it is preferred that the first fluorine-containing polymer be substantially free of a hydrogen atom and be fully fluorinated. Herein, saying that the fluorine-containing polymer is substantially free of a hydrogen atom means that the hydrogen atom content in the fluorine-containing polymer is 1 mol % or less.

The first fluorine-containing polymer preferably has a fluorine-containing aliphatic ring structure. The fluorine-containing aliphatic ring structure may be included in a main chain of the fluorine-containing polymer, or may be included in a side chain of the first fluorine-containing polymer. The first fluorine-containing polymer has, for example, a structural unit (A) represented by the following formula (1).

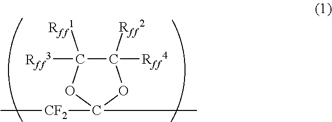

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring. “Perfluoro” indicates that every hydrogen atom bonded to a carbon atom is substituted by a fluorine atom. In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (1), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

In the case where R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) include structural units represented by the following formulae (A1) to (A8).

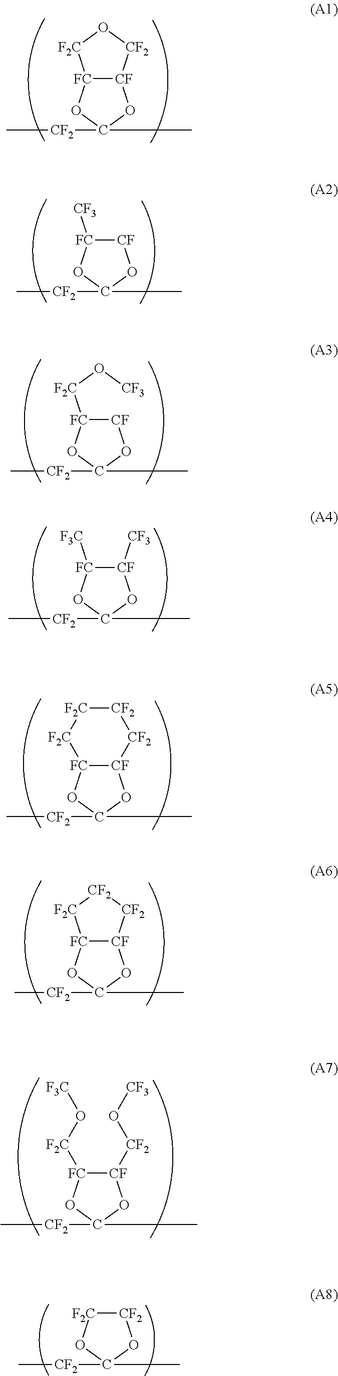

Among the structural units represented by the above formulae (A1) to (A8), the structural unit (A) is preferably the structural unit (A2), i.e., a structural unit represented by the following formula (5).

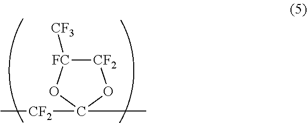

The first fluorine-containing polymer may include one or more structural units (A). In the first fluorine-containing polymer, the amount of the structural unit (A) is preferably 20 mol % or more and more preferably 40 mol % or more of a total amount of all structural units. When including 20 mol % or more of the structural unit (A), the first fluorine-containing polymer tends to have much higher thermal resistance. When including 40 mol % or more of the structural unit (A), the first fluorine-containing polymer tends to have much higher transparency and much higher mechanical strength in addition to high thermal resistance. In the first fluorine-containing polymer, the amount of the structural unit (A) is preferably 95 mol % or less and more preferably 70 mol % or less of the total amount of all structural units.

The structural unit (A) is derived from, for example, a compound represented by the following formula (6). In the formula (6), R_{ff}¹ to R_{ff}⁴ are as described in the formula (1). It should be noted that the compound represented by the formula (6) can be obtained, for example, by an already-known manufacturing method such as a manufacturing method disclosed in JP 2007-504125 A.

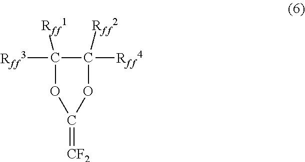

Specific examples of the compound represented by the above formula (6) include compounds represented by the following formulae (M1) to (M8).

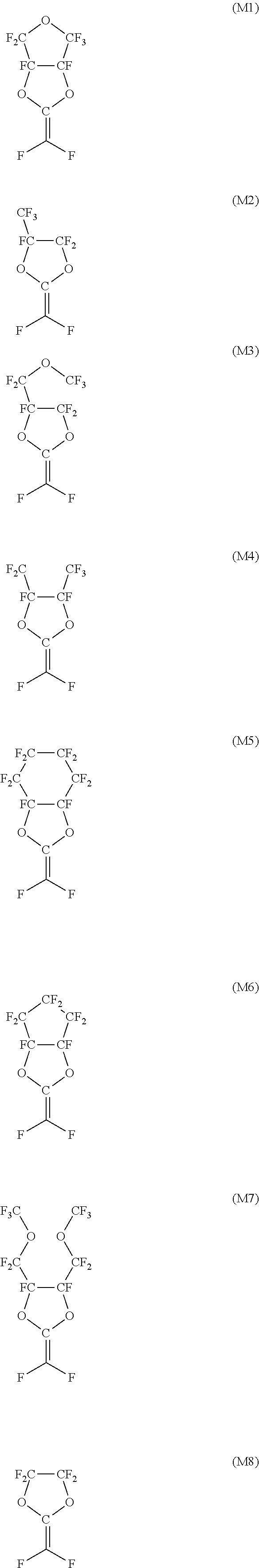

The fluorine-containing polymer may further include an additional structural unit other than the structural unit (A). Examples of the additional structural unit include the following structural units (B) to (D).

The structural unit (B) is represented by the following formula (2).

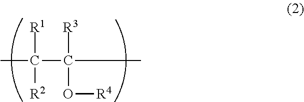

In the formula (2), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group is optionally a ring structure. One or some of the fluorine atoms are each optionally substituted by a halogen atom other than a fluorine atom. One or some of fluorine atoms in the perfluoroalkyl group are each optionally substituted by a halogen atom other than a fluorine atom.

The fluorine-containing polymer may include one or more structural units (B). In the fluorine-containing polymer, the amount of the structural unit (B) is preferably 5 to 10 mol % of the total amount of all structural units. The amount of the structural unit (B) may be 9 mol % or less or 8 mol % or less.

The structural unit (B) is derived from, for example, a compound represented by the following formula (7). In the formula (7), R¹ to R⁴ are as described for the formula (2). The compound represented by the formula (7) is a fluorine-containing vinyl ether such as perfluorovinyl ether.

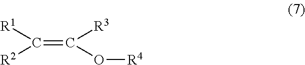

The structural unit (C) is represented by the following formula (3).

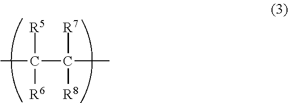

In the formula (3), R⁵ to R⁸ each independently represent a fluorine atom or a perfluoroalkyl group having 1 to 7 carbon atoms. The perfluoroalkyl group optionally has a ring structure. One or some of the fluorine atoms are each optionally substituted by a halogen atom other than a fluorine atom. One or some of fluorine atoms in the perfluoroalkyl group are each optionally substituted by a halogen atom other than a fluorine atom.

The fluorine-containing polymer may include one or more structural units (C). In the fluorine-containing polymer, the amount of the structural unit (C) is preferably 5 to 10 mol % of the total amount of all structural units. The amount of the structural unit (C) may be 9 mol % or less or 8 mol % or less.

The structural unit (C) is derived from, for example, a compound represented by the following formula (8). In the formula (8), R⁵ to R⁸ are as described for the formula (3). The compound represented by the formula (8) is a fluorine-containing olefin such as tetrafluoroethylene or chlorotrifluoroethylene.

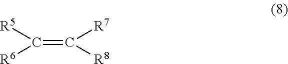

The structural unit (D) is represented by the following formula (4).

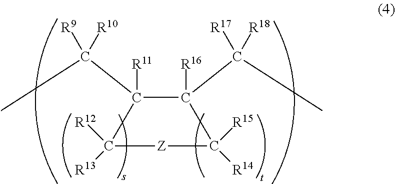

In the formula (4), Z represents an oxygen atom, a single bond, or —OC(R¹⁹R²⁰)O—, and R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms are each optionally substituted by a halogen atom other than a fluorine atom. One or some of fluorine atoms in the perfluoroalkyl group are each optionally substituted by a halogen atom other than a fluorine atom. One or some of fluorine atoms in the perfluoroalkoxy group are each optionally substituted by a halogen atom other than a fluorine atom. Symbols s and t are each independently 0 to 5, and s+t is an integer of 1 to 6 or, in the case where Z is —OC(R¹⁹R²⁰)O—, s+t is optionally 0.

The structural unit (D) is preferably represented by the following formula (9). The structural unit represented by the following formula (9) is a structural unit represented by the above formula (4), where Z is an oxygen atom, s is 0, and t is 2.

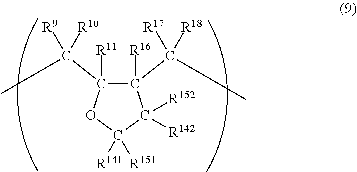

In the formula (9), R¹⁴¹, R¹⁴², R¹⁵¹, and R¹⁵² are each independently a fluorine atom, a perfluoroalkyl group having 1 to 5 carbon atoms, or a perfluoroalkoxy group having 1 to 5 carbon atoms. One or some of the fluorine atoms are each optionally substituted by a halogen atom other than a fluorine atom. One or some of fluorine atoms in the perfluoroalkyl group are each optionally substituted by a halogen atom other than a fluorine atom. One or some of fluorine atoms in the perfluoroalkoxy group are each optionally substituted by a halogen atom other than a fluorine atom.

The fluorine-containing polymer may include one or more structural units (D). In the fluorine-containing polymer, the amount of the structural unit (D) is preferably 30 to 67 mol % of the total amount of all structural units. The amount of the structural unit (D) is, for example, 35 mol % or more, and may be 60 mol % or less or 55 mol % or less.

The structural unit (D) is derived from, for example, a compound represented by the following formula (10). In the formula (10), Z, R⁹ to R¹⁸, s, and t are as described for the formula (4). The compound represented by the formula (10) is a cyclopolymerizable fluorine-containing compound having two or more polymerizable double bonds.

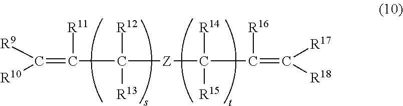

The structural unit (D) is preferably derived from a compound represented by the following formula (11). In the formula (11), R¹⁴¹, R¹⁴², R¹⁵¹, and R¹⁵² are as described for the formula (9).

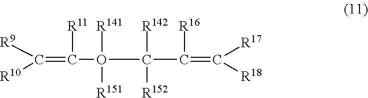

Specific examples of the compound represented by the formula (10) or the formula (11) include the following compounds.
CF₂═CFOCF₂CF═CF₂
CF₂═CFOCF(CF₃)CF═CF₂
CF₂═CFOCF₂CF₂CF═CF₂
CF₂═CFOCF₂CF(CF₃)CF═CF₂
CF₂═CFOCF(CF₃)CF₂CF═CF₂
CF₂═CFOCFClCF₂CF═CF₂
CF₂═CFOCCl₂CF₂CF═CF₂
CF₂═CFOCF₂OCF═CF₂
CF₂═CFOC(CF₃)₂OCF═CF₂
CF₂═CFOCF₂CF(OCF₃)CF═CF₂
CF₂═CFCF₂CF═CF₂
CF₂═CFCF₂CF₂CF═CF₂
CF₂═CFCF₂OCF₂CF═CF₂
CF₂═CFOCF₂CFClCF═CF₂
CF₂═CFOCF₂CF₂CCl═CF₂
CF₂═CFOCF₂CF₂CF═CFCl
CF₂═CFOCF₂CF(CF₃)CCl═CF₂
CF₂═CFOCF₂OCF═CF₂
CF₂═CFOCCl₂OCF═CF₂
CF₂═CClOCF₂OCCl═CF₂

The first fluorine-containing polymer may further include an additional structural unit other than the structural units (A) to (D). However, the first fluorine-containing polymer is preferably substantially free of an additional structural unit other than the structural units (A) to (D). Saying that the fluorine-containing polymer is substantially free of an additional structural unit other than the structural units (A) to (D) means that the sum of the amounts of the structural units (A) to (D) is 95 mol % or more and preferably 98 mol % or more of the total amount of all structural units in the fluorine-containing polymer.

The polymerization method for the first fluorine-containing polymer is not limited to a particular one, and, for example, a common polymerization method such as radical polymerization can be used. A polymerization initiator for the polymerization of the fluorine-containing polymer may be a fully fluorinated compound.

The first fluorine-containing polymer makes up the first fluorine-containing resin used as the first resin. A first glass transition temperature Tg₁ of the first resin is, for example, but not particularly limited to, 100° C. to 140° C., and may be 105° C. or higher or 120° C. or higher. Herein, the term “glass transition temperature” refers to a midpoint glass transition temperature (T_{mg}) determined according to JIS K 7121: 1987.

The refractive index of the core 11 is not limited to a particular value as long as the refractive index of the core 11 is higher than the refractive index of the cladding 12. To achieve the POF 10 having a high numerical aperture, it is preferred that a difference between the refractive index of the core 11 and the refractive index of the cladding 12 be large at a wavelength of light used. For example, the refractive index of the core 11 can be 1.320 or more or even 1.330 or more at a wavelength of light used (e.g., a wavelength of 850 nm). The upper limit of the refractive index of the core 11 is, for example, but not particularly limited to, 1.4000 or less.

### (Cladding 12)

In the POF 10 of the present embodiment, the cladding 12 includes, for example, a second resin. The cladding 12 may include the second resin as its main component. Here, saying that the cladding 12 includes the second resin as its main component means that the second resin is a component whose content is highest in the cladding 12 on a mass basis. The second resin content in the cladding 12 may be 80 mass % or more, 90 mass % or more, or 95 mass % or more. The cladding 12 may consist of the second resin. The cladding 12 may further include an additive in addition to the second resin.

The second resin included in the cladding 12 is not limited to a particular resin as long as the second resin has a high transparency. Examples of the second resin are the same as those shown as examples of the resin that can be used as the first resin. As in the case of the first resin, a fluorine-containing resin is suitably used as the second resin.

The second resin of the cladding 12 is preferably a fluorine-containing resin including a fluorine-containing polymer. Hereinafter, the fluorine-containing resin included in the cladding 12 is referred to as a second fluorine-containing resin, and the fluorine-containing polymer included in the second fluorine-containing resin is referred to as a second fluorine-containing polymer.

Examples of the fluorine-containing resin that can be used as the second fluorine-containing resin are the same as those mentioned as examples of the fluorine-containing resin that can be used as the first fluorine-containing resin. That is, examples of the fluorine-containing polymer that can be used as the second fluorine-containing polymer are the same as those mentioned as examples of the fluorine-containing polymer that can be used as the first fluorine-containing polymer.

The second fluorine-containing polymer makes up the second fluorine-containing resin used as the second resin. As described above, a second glass transition temperature Tg₂ of the second resin is not particularly limited, and is, for example, 100° C. to 150° C., and may be 105° C. or higher, or 125° C. or higher.

It is preferred that the second resin, which may be a resin different from the first resin, have an affinity for the first resin. For example, the second resin may include the same polymerization unit as that in the first resin, or may be the same as the first resin. In these cases, delamination at the interface between the core 11 and the cladding 12 is less likely to occur and, for example, the transmission loss can be reduced.

The refractive index of the cladding 12 is not limited to a particular value as long as the refractive index of the cladding 12 is determined on the basis of the refractive index of the core 11. The cladding 12 may have a refractive index of, for example, 1.340 or less, 1.330 or less, 1.320 or less at a wavelength of light used (e.g., a wavelength of 850 nm).

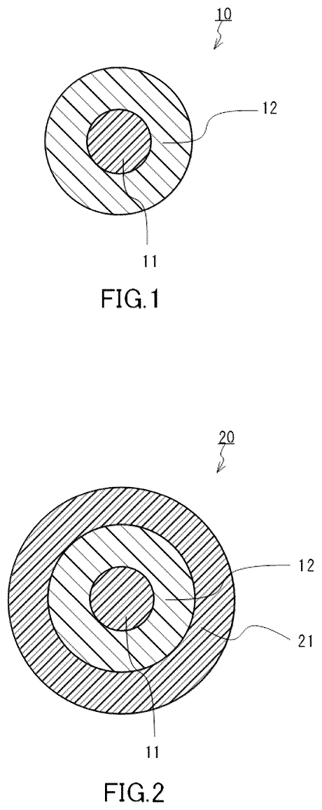

FIG. 2 shows a first modification of the POF of the present embodiment. A POF 20 as shown in FIG. 2 has a configuration in which the POF 10 is further provided with a reinforcing layer 21 disposed on an outer circumference of the cladding 12. The reinforcing layer 21 is provided to improve the mechanical strength of the POF 10. For example, a material and a configuration of a reinforcing layer of a known POF can be applied to the reinforcing layer 21. Examples of the material of the reinforcing layer 21 include various engineering plastics such as a polycarbonate, a polyester, a cycloolefin polymer, a cycloolefin copolymer, polytetrafluoroethylene (PTFE), a modified PTFE, a tetrafluoroethylene-perfluoroalkoxyethylene copolymer (PFA), a copolymer thereof, and a mixture thereof.

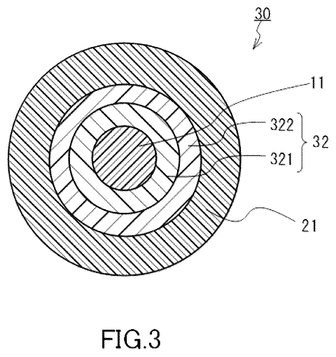

The cladding of the POF of the present embodiment may be composed of, for example, a plurality of layers. For example, the POF of the present embodiment may be a POF 30 including the core 11, a cladding 32 disposed on the outer circumference of the core, a coating layer 21 disposed on the outer circumference of the cladding, as in a second modification shown in FIG. 3. The cladding 32 of the POF 30 has a double-cladding structure, which is a two-layer structure composed of a first cladding layer 321 disposed in contact with the core 11 and a second cladding layer 322 disposed closer to an outer circumference of the POF 30 than the first cladding layer 321 is. In the POF 30, the coating layer 21 is in contact with the second cladding layer 322. The cladding 32 has a two-layer structure in the example shown in FIG. 3; however, the number of layers in the cladding 32 is not limited to two, and three or more layers may be included.

### (POF Production Method)

The POF of the present embodiment is produced, for example, by melt spinning. That is, one example of the method for producing the POF of the present embodiment includes:
producing a fiber-shaped extrusion-molded body by melting a core material and extruding the molten core material into a fiber shape, the fiber-shaped extrusion-molded body being made of the core material; and
producing a layered body by melting a cladding material and extruding the molten cladding material to coat a surface of the extrusion-molded body, the layered body including the core material and the cladding material concentrically layered. The above core material includes, for example, the first resin. The above cladding material includes, for example, the second resin.

When the POF 20 shown in FIG. 2 is manufactured, the above manufacturing method may further include drawing down the above layered body under heating at a given temperature to spin the layered body.

When the POF 30 shown in FIG. 3 is manufactured, for example, a material (first cladding material) for formation of the first cladding layer 321 and a material (second cladding material) for formation of the second cladding layer 322 are prepared as a cladding material. When the layered body including the core material and the cladding material concentrically layered is produced by the above manufacturing method, the first cladding material may be molten and extruded to coat the surface of the fiber-shaped extrusion-molded body made of the core material, and the molten second cladding material may be extruded to coat a surface of the first cladding material to produce a layered body including the core material, the first cladding material, and the second cladding material concentrically layered.

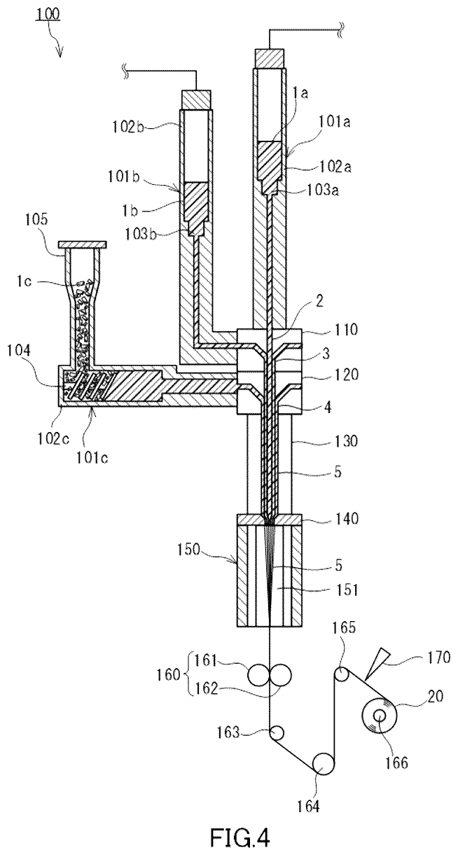

FIG. 4 is a schematic cross-sectional view showing an example of a manufacturing apparatus that can be used for manufacturing the POF 20 shown in FIG. 2.

An apparatus 100 shown in FIG. 4 includes a first extrusion apparatus 101a for core formation, a second extrusion apparatus 101b for cladding formation, and a third extrusion apparatus 101c for reinforcing layer formation. The apparatus 100 further includes a first chamber 110 and a second chamber 120. The first chamber 110 and the second chamber 120 are vertically arranged in this order from top to bottom.

The first extrusion apparatus 101a includes a first holding portion 102a that holds a core material 1a and a first extrusion portion 103a that extrudes the core material 1a held in the first holding portion 102a from the first holding portion 102a. The first extrusion apparatus 101a may be further provided with a heating unit (not illustrated) such as a heater so that the core material 1a can be molten in the first holding portion 102a and that the molten core material 1a can be kept in a molten state until molded. In this case, for example, the core material (preform) 1a in a rod shape can be molten by being put into the first holding portion 102a through an upper opening portion of the first holding portion 102a and then being heated in the first holding portion 102a.

In the first extrusion apparatus 101a, the core material 1a is extruded from the first holding portion 102a through the first extrusion portion 103a, for example, by extrusion by gas to form a core 2. The core material 1a extruded through the first extrusion portion 103a to form the core 2 then moves vertically downward to be supplied to the first chamber 110 and the second chamber 120 in this order.

A second extrusion apparatus 101b includes a second holding portion 102b that holds a cladding material 1b and a second extrusion portion 103b that extrudes the cladding material 1b held in the second holding portion 102b from the second holding portion 102b. The second extrusion apparatus 101b extrudes the cladding material 1b in a molten state to coat an outer circumference of the core 2 made of the core material 1a extruded from the first extrusion apparatus 102a. Specifically, the cladding material 1b extruded from the second extrusion apparatus 101b is supplied to the first chamber 110. In the first chamber 110, a cladding 3 coating the outer circumference of the core 2 can be formed by coating the core 2 made of the core material 1a with the cladding material 1b. A layered body made of the core 2 and the cladding 3 coating the outer circumference of the core 2 moves from the first chamber 110 to the second chamber 120.

The third extrusion apparatus 101c includes, for example, a third holding portion 102c that holds a reinforcing layer material 1c, a screw 104 disposed in the third holding portion 102c, and a hopper 105 connected to the third holding portion 102c. In the third extrusion apparatus 101c, for example, the reinforcing layer material 1c in a pellet shape is supplied to the third holding portion 102c through the hopper 105. The reinforcing layer material 1c supplied to the third holding portion 102c becomes soft and flowable, for example, by being kneaded by the screw 104 under heating. The softened reinforcing layer material 1c is extruded from the third holding portion 102c by the screw 104.

The reinforcing layer material 1c extruded from the third extrusion apparatus 101c is supplied to the second chamber 120. A reinforcing layer 4 coating the outer circumference of the cladding 3 can be formed in the second chamber 120 by coating a surface of the layered body made of the core 2 and the cladding 3 with the reinforcing layer material 1c.

A layered body 5 including the core 2, the cladding 3, and the reinforcing layer 4 concentrically layered moves from the second chamber 120 to a diffusion tube 130 disposed vertically under the second chamber 120. For example, a heater (not illustrated) for heating the layered body may be disposed in the diffusion tube 130. The diffusion tube 130 can diffuse a dopant such as a refractive index modifier in the layered body 5, the dopant being included in the layered body 5 passing through the diffusion tube 130. As for the diffusion tube 130, for example, the time required for the layered body 5 to pass through the diffusion tube 130, the length of the diffusion tube 130, the spinning rate, the temperature, etc. are adjusted as appropriate so that the transmission band of the POF 20 obtained at the end will be 30 MHz·km or more and 600 MHz·km or less.

The diffusion tube 130 communicates with an internal flow path of the nozzle 140. That is, a lower opening portion of the diffusion tube 130 communicates with an inlet of the nozzle 140, and the layered body 5 having passed through the diffusion tube 130 flows into the internal flow path through the inlet of the nozzle 140. The layered body 5 passes through the internal flow path to be reduced in diameter, and is then discharged into a fiber shape through an outlet of the nozzle 140.

The positions of the second chamber 120 and the diffusion tube 130 may be exchanged. That is, the apparatus may have a configuration in which the diffusion tube 130 is disposed below the first chamber 110, the second chamber 120 is disposed below the diffusion tube 130, and the nozzle 140 is installed below the second chamber.

The layered body 5 discharged into a fiber shape through the outlet of the nozzle 140 flows, for example, into an internal space 151 of a cooling pipe 150. The layered body 5 is cooled while passing through the internal space 151. The layered body 5 is then discharged from the cooling pipe 150 through an opening portion. The layered body 5 discharged from the cooling pipe 150, for example, passes between two rolls 161 and 162 of a nip roll 160 and then along guide rolls 163 to 165, and is wound as the POF 20 around a winding roll 166. A displacement meter 170 for measuring the outer diameter of the POF 20 may also be provided near the winding roll 166, such as between the guide roll 165 and the winding roll 166.

Here, the manufacturing apparatus 100 configured to be suitable for manufacturing the POF 20 is taken as an example for detailed description. The manufacturing apparatus 100, however, can also be used to manufacture the POF 10.

When the POF 10 is manufactured using the manufacturing apparatus 100, the third extrusion apparatus 101c for reinforcing layer formation should be left unused.

When the POF 30 is manufactured, another extrusion apparatus should be added between the second extrusion apparatus 101b and the third extrusion apparatus 101c of the manufacturing apparatus 100. The added extrusion apparatus may have the same configuration, for example, as that of the second extrusion apparatus 101b. In that case, the second extrusion apparatus 101b should be used for formation of the first cladding layer 321, and the newly added extrusion apparatus should be used for formation of the second cladding layer 322. Furthermore, in the above case, a third chamber for formation of the second cladding layer 322 is provided between the first chamber 110 and the second chamber 120. That is, the cladding 3 (corresponding to the first cladding layer) coating the outer circumference of the core 2 is formed by coating the core 2 made of the core material 1a with the cladding material 1b (first cladding material) inside the first chamber 110. The layered body composed of the core 2 and the cladding 3 (corresponding to the first cladding layer) coating the outer circumference of the core 2 moves from the first chamber 110 to the third chamber, and, in the third chamber, an outer circumference of the layered body is coated with the second cladding material extruded from the extrusion apparatus for formation of the second cladding layer 322. The layered body composed of the core 2, the cladding 3 (corresponding to the first cladding layer) coating the outer circumference of the core 2, and the second cladding layer coating the outer circumference of the cladding 3 moves from the third chamber to the second chamber 120, and a coating layer is formed in the second chamber 120.

### EXAMPLES

Hereinafter, the present disclosure will be described in more detail with reference to Examples and Comparative Examples. The present disclosure is however not limited by these.

### Example 1

### Production of First Fluorine-Containing Resin and Second Fluorine-Containing Resin

A polymer of perfluoro-4-methyl-2-methylene-1,3-dioxolane (PFMMD, the compound represented by the above formula (M2)) was prepared as the first fluorine-containing resin and the second fluorine-containing resin. The perfluoro-4-methyl-2-methylene-1,3-dioxolane was synthesized by synthesizing 2-carbomethyl-2-trifluoromethyl-4-methyl-1,3-dioxolane, fluorinating the 2-carbomethyl-2-trifluoromethyl-4-methyl-1,3-dioxolane, and then decarboxylating the resulting carboxylic acid salt. In the polymerization of the perfluoro-4-methyl-2-methylene-1,3-dioxolane, perfluorobenzoyl peroxide was used as a polymerization initiator.

The synthesis of 2-carbomethyl-2-trifluoromethyl-4-methyl-1,3-dioxolane, the fluorination of 2-carbomethyl-2-trifluoromethyl-4-methyl-1,3-dioxolane, the synthesis of perfluoro-4-methyl-2-methylene-1,3-dioxolane, and the polymerization of perfluoro-4-methyl-2-methylene-1,3-dioxolane will be described hereinafter in details.

### Synthesis of 2-carbomethyl-2-trifluoromethyl-4-methyl-1,3-dioxolane

A 3 L three-neck flask equipped with a water-cooled chiller, a thermometer, a magnetic stirrer, and a pressure equalizing dropping funnel were prepared. An amount of 139.4 g (1.4 mols in total) of a mixture of 2-chloro-1-propanol and 1-chloro-2-propanol was put in the flask. The flask was cooled to 0° C., methyl trifluoropyruvate was slowly added thereto, and the contents were stirred for 2 hours. An amount of 100 mL of dimethyl sulfoxide (DMSO) and 194 g of potassium carbonate were added thereto over one hour, and the contents were stirred for eight hours to obtain a reaction mixture. The reaction mixture generated was mixed with 1 L of water, and an aqueous phase of the resulting mixture was separated. After extraction was performed with dichloromethylene, the dichloromethylene solution was mixed with an organic reaction mixture phase. The resulting solution was dried by magnesium sulfate. After the removal of the solvent, 245.5 g of an unrefined product was obtained. This unrefined product was fractionated under a reduced pressure (12 Torr) to obtain 230.9 g of a refined product, 2-carbomethyl-2-trifluoromethyl-4-methyl-1,3-dioxolane. The boiling point of the refined product was 77 to 78° C., and the percentage yield was 77%. HNMR and ¹⁹F NMR were used to confirm that the obtained refined product was 2-carbomethyl-2-trifluoromethyl-4-methyl-1,3-dioxolane.

HNMR (ppm): 4.2 to 4.6, 3.8 to 3.6 (CHCH₂, multiplet, 3H), 3.85 to 3.88 (COOCH₃, multiplet, 3H), 1.36 to 1.43 (CCH₃, multiplet, 3H)

¹⁹F NMR (ppm): −81.3 (CF₃, s, 3F)

### Fluorination of 2-carbomethyl-2-trifluoromethyl-4-methyl-1,3-dioxolane

An amount of 4 L of 1,1,2-trichlorotrifluoroethane was introduced into a 10 L stirred reaction vessel. In the stirred reaction vessel, nitrogen and fluorine were allowed to flow at a flow rate of 1340 cc/min and 580 cc/min, respectively, to create a nitrogen-fluorine atmosphere. Five minutes later, 290 g of the 2-carbomethyl-2-trifluoromethyl-4-methyl-1,3-dioxolane prepared beforehand was dissolved in 750 mL of a 1,1,2-trichlorotrifluoroethane solution, which was then added into the reaction vessel at 0.5 ml/min. The reaction vessel was cooled to 0° C. After the dioxolan was all added over 24 hours, the fluorine gas flow was stopped. The nitrogen gas was purged, and subsequently an aqueous potassium hydroxide solution was added until the mixture became weak alkaline.

After a volatile substance was removed under a reduced pressure, the reaction vessel was cooled. The cooling was followed by a 48-hour drying under a reduced pressure at 70° C. to obtain a solid reaction product. The solid reaction product was dissolved in 500 mL of water, to which an excessive amount of hydrochloric acid was added to separate the mixture into an organic phase and an aqueous phase. The organic phase was separated and distilled under a reduced pressure to obtain perfluoro-2,4-dimethyl-1,3-dioxolane-2-carboxylic acid. The boiling point of the main distillate was 103° C.-106° C./100 mmHg. The percentage yield of the fluorination was 85%.

### Synthesis of perfluoro-4-methyl-2-methylene-1,3-dioxolane

The above distillate was neutralized with an aqueous potassium hydroxide solution to obtain perfluoro-2,4-dimethyl-2-potassium carboxylate-1,3-dioxolane. This potassium salt was vacuum-dried at 70° C. for one day. The salt was decomposed at 250° C. to 280° C. under a nitrogen or argon atmosphere. Through condensation in a cold trap cooled at −78° C., perfluoro-4-methyl-2-methylene-1,3-dioxolane was obtained at a percentage yield of 82%. The boiling point of the product was 45° C./760 mmHg. The product was identified by ¹⁹F NMR and GC-MS.

¹⁹F NMR: −84 ppm (3F, CF₃), −129 ppm (2F, ═CF₂)

GC-MS: m/e244 (Molecular ion) 225, 197, 169, 150, 131, 100, 75, 50.

### Polymerization of perfluoro-4-methyl-2-methylene-1,3-dioxolane

An amount of 100 g of the perfluoro-4-methyl-2-methylene-1,3-dioxolane obtained in the above manner and 1 g of perfluorobenzoyl peroxide were put in a glass tube, which was then sealed. After oxygen in the system was removed by freeze-pump-thaw cycling, the glass tube was charged with argon and then heated at 50° C. for several hours. The contents thereby turned solids, which were further heated at 70° C. overnight to obtain 100 g of a transparent stick.

The transparent stick obtained was dissolved in Fluorinert FC-75 (manufactured by Sumitomo 3M), and the resulting solution was poured onto a glass sheet to obtain a thin polymer film. The polymer had a glass transition temperature of 117° C., and was completely amorphous. The transparent stick was dissolved in a hexafluorobenzene solution, to which chloroform was added for precipitation. The product was thereby refined. A polymer resulting from the refinement had a glass transition temperature of approximately 131° C. This polymer was used as the first fluorine-containing resin and the second fluorine-containing resin.

### [Refractive Index Modifier]

A chlorotrifluoroethylene oligomer (molecular weight: 585) was used as a refractive index modifier. Specifically, only a component obtained by distillation of DAIFLOIL #10 manufactured by DAIKIN INDUSTRIES, LTD. was used, the component having a molecular weight of 585.

### [Core Material]

The first fluorine-containing resin produced in the above manner was dissolved in Vertrel XF-UP (manufactured by Chemours-Mitsui Fluoroproducts Co., Ltd.) serving as a solvent. The solution was filtered through a filter “LPJ-CTA-001-N3” (manufactured by ROKI TECHNO CO., LTD.) having a pore diameter of 100 nm, and the filtrate was dropped on a Hastelloy container heated at 260° C. to evaporate the solvent to dryness. The filtered first fluorine-containing resin obtained by the drying and the above refractive index modifier were molten and mixed at 260° C. to produce a resin composition. The refractive index modifier concentration in the resin composition was 12 mass %. This resin composition was used as a core material.

### [First Cladding Material]

The Second Fluorine-Containing Resin Produced in the Above Manner was Filtered in the same manner as for the filtration of the first fluorine-containing resin in the production of the core material, and thus a filtered second fluorine-containing resin was obtained. This filtered second fluorine-containing resin was used as a first cladding material for formation of a first cladding layer.

### [Second Cladding Material]

“Teflon AF1600” (manufactured by Chemours-Mitsui Fluoroproducts Co., Ltd.) serving as a fluorine resin and “Fomblin YR” (manufactured by Solvay S.A.) serving as a viscosity modifier were dissolved in Vertrel XF-UP (manufactured by Chemours-Mitsui Fluoroproducts Co., Ltd.) serving as a solvent. A mixing ratio between “Teflon AF1600” and “Fomblin YR” was “Teflon AF1600”: “Fomblin YR”=7:3 in mass. The solution obtained was filtered through a filter “LPA-SLF-003-N2” (manufactured by ROKI TECHNO CO., LTD.) having a pore diameter of 300 nm, and the filtrate was dropped on a Hastelloy container heated at 260° C. to evaporate the solvent to dryness. The resin composition obtained by the drying was used as a second cladding material.

### [Reinforcing Layer Material]

Xylex (manufactured by SABIC Innovative Plastics; glass transition temperature: 113° C.) was used as a reinforcing layer material.

### [POF]

The POF having the same configuration as that of the POF 30 shown in FIG. 3 was produced by melt spinning using the core material, the first cladding material, the second cladding material, and the reinforcing layer prepared in the above manners. For the production of the POF, a manufacturing apparatus including the manufacturing apparatus 100 shown in FIG. 4 and another extrusion apparatus for second cladding layer formation added between the second extrusion apparatus 101b and the third extrusion apparatus 101c of the manufacturing apparatus 100 was used. The added extrusion apparatus had the same configuration as that of the second extrusion apparatus 101b. That is, in the present example, the second extrusion apparatus 101b was used for formation of the first cladding layer 321, and the added extrusion apparatus was used for formation of the second cladding layer 322. The third chamber for formation of the second cladding layer 322 was provided between the first chamber 110 and the second chamber 120.

The core material had a melting temperature of 250° C., the first cladding material had a melting temperature of 255° C., the second cladding material had a melting temperature of 260° C., and the reinforcing layer material had a melting temperature of 240° C. The temperature of the diffusion tube 130 was set to 260° C. The drawing temperature of a layered body composed of the core, the cladding (the first and second cladding layers), and the reinforcing layer was 240° C.

Melt extrusion was performed in which volume rates of the materials discharged was the first cladding material: 1.5; the second cladding material: 1.5; and the reinforcing layer material: 50, with respect to the core material: 1. The diffusion time, i.e., the time required for the layered body to pass through the diffusion tube 130 was 960 seconds.

In the resulting POF, the core diameter was 49 μm, and the outer diameter of the reinforcing layer (namely, the outer diameter of the POF) was 235 μm. The core diameter was measured by the following method.

### [Evaluation of Core Diameter]

The core diameter was measured by an NFP method, which is one of the methods according to IEC 60793-1-20 and IEC 60793-2-40 sub-category A4h, using light with a wavelength of 850 nm. A 6 m-long POF was prepared, and LED light with a wavelength of 850 nm was allowed to be incident on one end portion of the POF. A light intensity distribution of output light at a distance of 6 m was measured, and then a diameter at which the light intensity is 5% was determined.

### [Evaluation of Numerical Aperture (NA)]

The NA was measured by a far field pattern (FFP) method, which is one of the methods according to IEC 60793-1-43 and IEC 60793-2-40 subcategory A4h, using light with a wavelength of 850 nm. A 6 m-long POF was prepared, and LED light with a wavelength of 850 nm was allowed to be incident on one end portion of the POF. A light intensity distribution at angular positions of output light was measured at a distance of 6 m, and then the NA was calculated.

### [Evaluation of Transmission Loss]

The transmission loss was measured by a cut-back method, which is one of methods according to IEC 60793-1-40. A40 m-long POF was prepared, and LED light with 850 nm was allowed to be incident on one end portion of the POF. The light intensity of output light was measured by a power meter. The POF was cut shorter and shorter by one meter, and the light intensity was measured for each length of the POF. The transmission loss was determined from the variation in light intensity.

### [Evaluation of Band]

The band was measured by a pulse method which is one of the methods according to IEC 60793-1-41. A 20 m-long POF was prepared. An optical pulse was allowed to be incident on one end portion of the POF, and an optical pulse of output light was measured at a distance of 20 m. After that, the POF was cut to a length of 2 m. In the same manner, an optical pulse was allowed to be incident thereon and an output pulse was measured. For the two output pulses, a transfer function was determined by Fourier transform specified in IEC 60793-1-41, and a frequency at an optical power of −3 dB was determined.

### [Evaluation of M² Value]

The M² value was evaluated by the same method as that described in JP 2019-049658 A. That is, a beam radius W (Dσ4) and a beam divergence θ (half angle) defined using a secondary moment were determined by the same method as that described in the paragraph 0088 of JP 2019-049658 A with the use of a measurement system equivalent to the one for NFP and FFP shown in FIG. 3 of JP 2019-049658 A. The results were used to determine the M² value by the following mathematical formula (1).

$${M}^{2} = π W θ / λ \qquad Mathematical formula ( 1 )$$

### [Evaluation of BER]

The BER was evaluated by the same method as that described in JP 2019-049658 A. That is, the BER was determined by the same method as that described in the paragraph 0089 of JP 2019-049658 A with the use of a measurement system equivalent to the one shown in FIG. 4 of JP 2019-049658 A.

### Example 2

A POF was produced in the same manner as in Example 1, except for the following points.
in production of the POF, the melt extrusion was performed in which the volume rates of the materials discharged were the first cladding material: 1.5; the second cladding material: 1.5; and the reinforcing layer material: 90, with respect to the core material: 1.
The length of the diffusion tube and the spinning rate were adjusted so that the time required for the layered body to pass through the diffusion tube 130 would be 1000 seconds.

In the POF obtained, the core diameter measured in the same manner as in Example 1 was 79 μm, and the outer diameter of the reinforcing layer (namely, the outer diameter of the POF) was 490 μm. The POF was evaluated for its properties in the same manner as in Example 1.

### Example 3

A POF having the same configuration as that of the POF 20 shown in FIG. 2 was produced. That is, a POF including a cladding composed of one layer was produced in Example 3. The first cladding material of Example 1 was prepared as a cladding material, and the second cladding material was not used. Differences between Example 3 and Example 1 are shown below. Except for the following points, the POF of Example 3 was produced in the same manner as in Example 1. In the POF obtained, the core diameter measured in the same manner as in Example 1 was 44 μm, and the outer diameter of the reinforcing layer (namely, the outer diameter of the POF) was 235 μm. The POF was evaluated for its properties in the same manner as in Example 1.

Differences from Example 1
In the production of the core material, the filtration of the first fluorine-containing resin was performed in such a manner that the first fluorine-containing resin solution was filtered through a filter “LPJ-CTA-001-N3” (manufactured by ROKI TECHNO CO., LTD.) having a pore diameter of 100 nm twice and then through a filter “DFA 1ANDESW44” (manufactured by Pall Corporation) having a pore diameter of 40 nm.
The refractive index modifier was filtered through a filter “DFA 1ANDESW44” (manufactured by Pall Corporation) having a pore diameter of 40 nm.
In the production of the POF, the second cladding material was not used and the second cladding layer was not formed.
The volume rates of the materials discharged were the first cladding material: 1.5; and the reinforcing layer material: 53, with respect to the core material: 1.

### Example 4

A POF was produced in the same manner as in Example 1, except for the following points.
In the Production of the Core Material, the Refractive Index Modifier to be Added was filtered through a filter “DFA 1ANDESW44” (manufactured by Pall Corporation) having a pore diameter of 40 nm.
The length of the diffusion tube and the spinning rate were adjusted so that the time required for the layered body to pass through the diffusion tube 130 would be 480 seconds.

In the POF obtained, the core diameter measured in the same manner as in Example 1 was 50 μm, and the outer diameter of the reinforcing layer (namely, the outer diameter of the POF) was 235 μm. The POF was evaluated for its properties in the same manner as in Example 1.

### Example 5

A POF was produced in the same manner as in Example 1, except for the following points.
In the production of the core material, without being dissolved in the solvent and filtered, the synthesized first fluorine-containing resin was directly molten and mixed together with the refractive index modifier by heating at 260° C. to produce a resin composition.
In the production of the first cladding material, the synthesized second fluorine-containing resin was directly used as the first cladding material without being dissolved in the solvent and filtered.
The temperature of the diffusion tube 130 was 265° C.

In the POF obtained, the core diameter measured in the same manner as in Example 1 was 50 μm, and the outer diameter of the reinforcing layer (namely, the outer diameter of the POF) was 235 μm. The POF was evaluated for its properties in the same manner as in Example 1.

### Example 6

A POF was produced in the same manner as in Example 1, except for the following points.
In the production of the core material and the first cladding material, the solution of the first fluorine-containing resin and the solution of the second fluorine-containing resin were each filtered through a filter “LPJ-CTA-001-N3” (manufactured by ROKI TECHNO CO., LTD.) having a pore diameter of 100 nm twice and then through a filter “DFA 1ANDESW44” (manufactured by Pall Corporation) having a pore diameter of 40 nm.
The refractive index modifier was filtered through a filter “DFA 1ANDESW44” (manufactured by Pall Corporation) having a pore diameter of 40 nm.
The temperature of the diffusion tube 130 was 265° C.
The length of the diffusion tube and the spinning rate were adjusted so that the time required for the layered body to pass through the diffusion tube 130 would be 1440 seconds.

In the POF obtained, the outer diameter of the core measured in the same manner as in Example 1 was 48 μm, and the outer diameter of the reinforcing layer (namely, the outer diameter of the POF) was 235 μm. The POF was evaluated for its properties in the same manner as in Example 1.

### Comparative Example 1

As the POF of Comparative Example 1 was used “FONTEX 50” manufactured by AGC Inc. The properties thereof were evaluated in the same manner as in Example 1.

### Comparative Example 2

A POF was produced in the same manner as in Example 1, except for the following points.
In production of the POF, the temperature of the diffusion tube was 250° C.
The length of the diffusion tube and the spinning rate were adjusted so that the time required for the layered body to pass through the diffusion tube 130 would be 480 seconds.

In the POF obtained, the outer diameter of the core measured in the same manner as in Example 1 was 50 μm, and the outer diameter of the reinforcing layer (namely, the outer diameter of the POF) was 235 μm. The POF was evaluated for its properties in the same manner as in Example 1.

Table 1 shows the evaluation results for the POFs of Examples and Comparative Examples.

TABLE 1

| | | | | Core | | | Transmission | | |
|---|---|---|---|---|---|---|---|---|---|
| | | Structure | Length | diameter | | Transmission | band | M² | |
| | | of POF | [m] | [μm] | NA | loss [dB/km] | [MHz · km] | value | BER |
| Example | 1 | 4-layered | 10 | 49 | 0.222 | 223 | 122 | 5.9 | 4.36 × 10⁻⁹ |
| | 2 | 4-layered | 15 | 79 | 0.22 | 219 | 133 | 3.2 | 9.25 × 10⁻⁸ |
| | 3 | 3-layered | 30 | 44 | 0.173 | 76 | 555 | 4.3 | 4.03 × 10⁻¹⁰ |
| | 4 | 4-layered | 10 | 50 | 0.225 | 180 | 40 | 2.5 | 1.35 × 10⁻⁸ |
| | 5 | 4-layered | 10 | 50 | 0.219 | 441 | 142 | 3.5 | 3.78 × 10⁻⁸ |
| | 6 | 4-layered | 25 | 48 | 0.22 | 98 | 180 | 2.1 | 8.83 × 10⁻⁸ |
| Comparative | 1 | FONTEX | 15 | 55 | 0.23 | 45 | 207 | 1.6 | 3.11 × 10⁻⁶ |
| Example | | 50 | | | | | | | |
| | 2 | 4-layered | 15 | 50 | 0.225 | 222 | 26 | 6.9 | 1.12 × 10⁻⁵ |

The POFs of Examples 1 to 6 whose transmission losses at a wavelength of 850 nm are 70 dB/km or more and 500 dB/km or less and whose transmission bands at a wavelength of 850 nm are 30 MHz·km or more and 600 MHz·km or less were able to achieve as low a BER as 1×10⁻⁷ or less. The BER of the POF of Comparative Example 1 whose transmission loss is less than 70 dB/km is 3.11×10⁻⁶, which is higher than those of the POFs of Examples 1 to 6. Although the POF of Comparative Example 2 whose transmission band is less than 30 MHz·km has an M² value of 1.7 or more, the BER of the POF of Comparative Example 2 is 1.12×10⁻⁵, which is higher than those of the POFs of Examples 1 to 6. These results confirm that a POF having a length of 30 m or less and a core diameter of 30 μm or more and 100 μm or less can have improved transmission quality in short-distance signal transmission when satisfying a transmission loss of 70 dB/km or more and 500 dB/km or less and a transmission band of 30 MHz·km or more and 600 MHz·km or less.

For comparison, a POF produced in the same manner as in Example 2 and having a length of 40 m was evaluated for the BER; the BER was as poor as 2.20×10⁻². This reveals that the present disclosure provides a technique for effectively solving the issue a POF having a length of 30 m or less experiences in short-distance signal transmission.

### INDUSTRIAL APPLICABILITY

The POF of the present disclosure is suitable for applications such as short-distance signal transmission, for example, in home.

1. A plastic optical fiber comprising:
a core; and
a cladding disposed on an outer circumference of the core, wherein
the plastic optical fiber has a length of 30 m or less,
the core has a diameter of 30 μm or more and 100 μm or less,
a transmission loss at a wavelength of 850 nm is 70 dB/km or more and 500 dB/km or less, and
a transmission band at a wavelength of 850 nm is 30 MHz·km or more and 600 MHz·km or less.

2. The plastic optical fiber according to claim 1, wherein the plastic optical fiber is a graded-index plastic optical fiber.

3. The plastic optical fiber according to claim 1, wherein
the core includes a first resin, and
the first resin is at least one selected from the group consisting of a fully fluorinated resin, a partially fluorinated resin, a partially chlorinated resin, and a partially deuterated resin.

4. The plastic optical fiber according to claim 3, wherein the first resin is at least one selected from the group consisting of the fully fluorinated resin and the partially fluorinated resin.

5. The plastic optical fiber according to claim 4, wherein the first resin includes a fluorine-containing polymer including a structural unit (A) represented by the following formula (1): 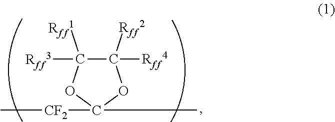
where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are optionally linked to form a ring.

6. The plastic optical fiber according to claim 5, wherein the fluorine-containing polymer further includes a structural unit (B) represented by the following formula (2): 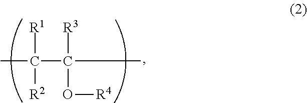
where R¹ to R³ each independently represent a fluorine atom or a perfluoroalkyl group having 1 to 7 carbon atoms, R⁴ represents a perfluoroalkyl group having 1 to 7 carbon atoms, the perfluoroalkyl group optionally has a ring structure, one or some of the fluorine atoms are each optionally substituted by a halogen atom other than a fluorine atom, and one or some of fluorine atoms in the perfluoroalkyl group are each optionally substituted by a halogen atom other than a fluorine atom.

7. The plastic optical fiber according to claim 5, wherein the fluorine-containing polymer further includes a structural unit (C) represented by the following formula (3): 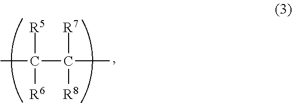
where R⁵ to R⁸ each independently represent a fluorine atom or a perfluoroalkyl group having 1 to 7 carbon atoms, the perfluoroalkyl group optionally has a ring structure, one or some of the fluorine atoms are each optionally substituted by a halogen atom other than a fluorine atom, and one or some of fluorine atoms in the perfluoroalkyl group are each optionally substituted by a halogen atom other than a fluorine atom.

8. The plastic optical fiber according to claim 5, wherein the fluorine-containing polymer further includes a structural unit (D) represented by the following formula (4): 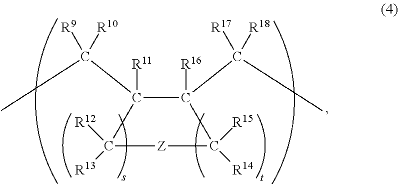
where Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms, one or some of the fluorine atoms are each optionally substituted by a halogen atom other than a fluorine atom, one or some of fluorine atoms in the perfluoroalkyl group are each optionally substituted by a halogen atom other than a fluorine atom, one or some of fluorine atoms in the perfluoroalkoxy group are each optionally substituted by a halogen atom other than a fluorine atom, s and t are each independently 0 to 5, and s+t is an integer of 1 to 6 or, in the case where Z is —OC(R¹⁹R²⁰)O—, s+t is optionally 0.

9. The plastic optical fiber according to claim 3, wherein the core further includes a refractive index modifier.

10. The plastic optical fiber according to claim 1, further comprising a reinforcing layer disposed on an outer circumference of the cladding.
